(19) United States
(12) Patent Application Publication
(10) Pub. No.: US 2024/0113844 A1
(43) Pub. Date: Apr. 4, 2024

(54) BEAM SWITCH RULES ASSOCIATED WITH SWITCHING BETWEEN MULTIPLE TRANSMISSION AND RECEPTION POINT (mTRP) and SINGLE TRP (sTRP)

(71) Applicant: QUALCOMM Incorporated, San Diego, CA (US)

(72) Inventors: Tianyang BAI, Somerville, NJ (US); Yan ZHOU, San Diego, CA (US); Tao LUO, San Diego, CA (US); Junyi LI, Fairless Hills, PA (US)

(21) Appl. No.: 18/447,895

(22) Filed: Aug. 10, 2023

Related U.S. Application Data
(60) Provisional application No. 63/377,875, filed on Sep. 30, 2022.

(51) Int. Cl. H04L 5/00; H04W 72/12; H04W 72/23

(52) U.S. Cl. CPC H04L 5/0094; H04L 5/0035; H04L 5/0053; H04W 72/12; H04W 72/23

(57) ABSTRACT

In a unified transmission configuration indicator (TCI) framework, certain channels are preconfigured to use a fixed number of TCI states. However, these preconfigured channels are not currently updated when the number of TCI states dynamically change during a switch between single and multiple transmission and reception point (TRP) modes. To alleviate this problem, a user equipment (UE) may receive downlink control information (DCI) indicating a first number of TCI states and, prior to the DCI, downlink information indicating a second number of TCI states, detect a switch between the multiple TRP (mTRP) and single TRP (sTRP) modes based on the first number of TCI states being different than the second number of TCI states, and communicate in a channel configured to use a selected TCI state associated with the first number of TCI states using a predefined rule based on the switch between the mTRP and sTRP modes.

### CROSS-REFERENCE TO RELATED APPLICATION

This application claims the benefit of U.S. Provisional Application No. 63/377,875, filed on Sep. 30, 2022, which is hereby incorporated by reference in its entirety.

### TECHNICAL FIELD

The present disclosure generally relates to communication systems, and more particularly, to beam switch rules associated with switching between multi-transmission and reception point (mTRP) and single TRP (sTRP).

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Various aspects of the present disclosure relate to wireless communication, particularly to the efficient handling of transmission configuration indication (TCI) states in user equipment (UE) when switching between single transmission and reception point (sTRP) mode and multiple transmission and reception point (mTRP) mode. In certain scenarios, channels, such as semi-persistently scheduled (SPS) physical downlink shared channel (PDSCH) or control resource sets (CORESETs), may be preconfigured assuming a fixed number of indicated TCIs. However, when the number of indicated TCI states dynamically changes due to the UE switching between sTRP and mTRP modes, the pre-configuration of these channels may not be updated accordingly. To address this issue, the present disclosure defines rules or behavior of the preconfigured channels upon detecting a change in the number of TRPs or TCI states. More specifically, if the UE receives downlink control information (DCI) indicating a number of TCI states (e.g., a first number of TCI states) which is different from a number of TCI states which were previously received (e.g., a second number of TCI states received in downlink information), the UE may detect the switch between mTRP and sTRP modes based on the difference between the first and second number of TCI states. The UE may communicate with the network entity in one or more channels configured to use a selected TCI state associated with the first number of TCI states following predefined rules based on the detected switch.

For example, when the first number of TCI states indicated in the DCI is greater than the second number of TCI states, the UE may detect the switch from the sTRP mode to the mTRP mode and thus determine the CORESET is configured to use the selected TCI state that corresponds to the smallest TRP identifier of TRP identifiers associated with the first number of TCI states. In another example, when the first number of TCI states indicated in the DCI is less than the second number of TCI states, the UE may detect the switch from the mTRP mode to the sTRP mode and thus determine the SPS PDSCH or the CG PUSCH is configured to use the selected TCI state associated with the first number of TCI states that are active for the UE. Other rules may be similarly defined in other examples, but in any event, this approach allows the UE to adapt to the dynamic changes in numbers of TCI states due to sTRP/mTRP mode switches, ensuring efficient communication with the network entity in various channels, such as physical downlink control channels (PDCCH), semi-persistent scheduling (SPS) physical downlink shared channels (PDSCH), and configured grant (CG) physical uplink shared channels (PUSCH). Furthermore, the UE may determine a quasi-co-location (QCL) assumption for the scheduled PDSCH based on the selected TCI state and support channel state information (CSI) reporting based on a Type II codebook for coherent joint transmission (CJT) in the mTRP mode, further enhancing the overall system performance and user experience in wireless communication networks. Aspects of this disclosure may lead to several potential advantages. By detecting the switch between sTRP and mTRP modes and communicating in configured channels accordingly using the predefined rules, the UE may maintain optimal communication performance in various channels, such as PDCCH, SPS PDSCH, and CG PUSCH.

For example, in response to determining the CORESET is configured to use the selected TCI state corresponding to the smallest TRP identifier during the switch from sTRP to mTRP mode, the UE may ensure efficient communication with the network entity with minimal complexity in determining the appropriate TCI state for communication in the mTRP mode. In another example, in response to determining the SPS PDSCH or CG PUSCH is configured to use the selected TCI state associated with the first number of TCI states that are active for the UE during the switch from mTRP to sTRP mode, the UE may adapt to the reduced number of TCI states, allowing for more robust or reliable communication in the sTRP mode. Based on these rules or other similar rules, this approach enables the UE to adapt to the dynamic changes in TCI states, ensuring efficient communication with the network entity. Furthermore, the ability to determine a QCL assumption for the scheduled PDSCH based on the selected TCI state allows the UE to optimize its reception performance, leading to improved overall system performance and user experience in wireless communication networks. Additionally, supporting CSI reporting based on a Type II codebook for CJT in the mTRP mode enables the UE to provide more accurate and relevant feedback to the network entity, facilitating better resource allocation and enhancing the overall performance of the wireless communication system.

In an aspect of the disclosure, a method, a computer-readable medium, and an apparatus are provided. An apparatus for wireless communication in accordance with an aspect of the present disclosure may comprise one or more memories; and one or more processors each communicatively coupled with at least one of the one or more memories, the one or more processors, individually or in any combination, operable to cause the apparatus to: receive, from a network entity, downlink control information (DCI) indicating a first number of transmission configuration indication (TCI) states; detect a switch between a multiple transmission and reception point (mTRP) mode and a single TRP (sTRP) mode in the UE based on the first number of TCI states being different than a second number of TCI states which were previously received by the UE; and communicate with the network entity in one or more channels configured to use a selected TCI state associated with the first number of TCI states using one or more predefined rules based on the switch between the mTRP mode and the sTRP mode.

An apparatus for wireless communication in accordance with an aspect of the present disclosure may comprise means for receiving, from a network entity, DCI indicating a first number of TCI states; means for detecting a switch between a mTRP mode and a sTRP mode in the UE based on the first number of TCI states being different than a second number of TCI states which were previously received by the UE; and means for communicating with the network entity in one or more channels configured to use a selected TCI state associated with the first number of TCI states using one or more predefined rules based on the switch between the mTRP mode and the sTRP mode.

A method of wireless communication in accordance with an aspect of the present disclosure may comprise receiving, from a network entity, DCI indicating a first number of TCI states; detecting a switch between a mTRP mode and a sTRP mode in the UE based on the first number of TCI states being different than a second number of TCI states which were previously received by the UE; and communicating with the network entity in one or more channels configured to use a selected TCI state associated with the first number of TCI states using one or more predefined rules based on the switch between the mTRP mode and the sTRP mode.

A non-transitory, computer-readable medium including computer executable code in accordance with an aspect of the present disclosure may have the code when executed by one or more processors of a UE, cause the one or more processors to, individually or in combination: receive, from a network entity, DCI indicating a first number of TCI states; detect a switch between a mTRP mode and a sTRP mode in the UE based on the first number of TCI states being different than a second number of TCI states which were previously received by the UE; and communicate with the network entity in one or more channels configured to use a selected TCI state associated with the first number of TCI states using one or more predefined rules based on the switch between the mTRP mode and the sTRP mode.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture in accordance with various aspects of the present disclosure.

FIG. 5 is a flow diagram of a beam selection rule during multiple transmission and reception point (mTRP) mode and single TRP (sTRP) mode dynamic switching in accordance with an aspect of the present disclosure.

FIG. 6 is a flowchart of a method of wireless communication in accordance with an aspect of the present disclosure.

FIG. 7 is a block diagram illustrating an example configuration of a default beam for receiving information in accordance with various aspects of the present disclosure.

FIG. 8 is a diagram illustrating an example of a hardware implementation for an example apparatus in accordance with an aspect of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Certain channels may be preconfigured assuming a fixed number of indicated transmission configuration indications (TCIs) (e.g., semi-persistently scheduled (SPS) physical downlink shared channel (PDSCH)), or its association with TCIs may be preconfigured (e.g., control resource sets (CORESETs)). However, when the number of indicated TCI states is dynamically changed, the pre-configuration of such channels is not currently updated accordingly. To alleviate this problem during multiple transmission and reception point (mTRP) and single TRP (sTRP) dynamic switch, it would be helpful to define the rules or behavior of the preconfigured channels after a detected change in the number of TRPs.

The present disclosure provides for configuring one or more channels to use a selected TCI state associated with a first number of TCI states using one or more predefined rules based on a dynamic switch between the mTRP mode and the sTRP mode, where the user equipment (UE) may detect the switch between the mTRP and sTRP modes in the UE based on a change in the first number of TCI states indicated in a downlink control information (DCI).

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

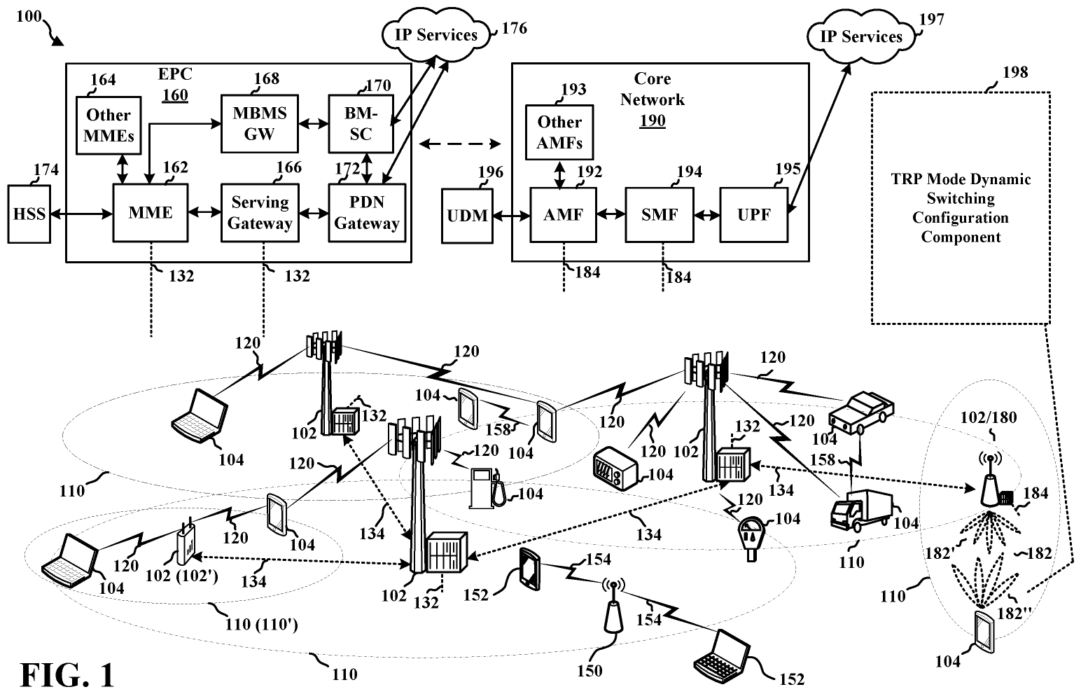

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

Referring again to FIG. 1, in certain aspects, the UE 104 may include TRP mode dynamic switching configuration component 198. The UE 104, via the TRP mode dynamic switching configuration component 198, may be configured to receive, from a network entity, DCI indicating a first number of TCI states; detect a switch between a mTRP mode and a sTRP mode in the UE based on the first number of TCI states being different than a second number of TCI states which were previously received by the UE; and communicate with the network entity in one or more channels configured to use a selected TCI state associated with the first number of TCI states using one or more predefined rules based on the switch between the mTRP mode and the sTRP mode.

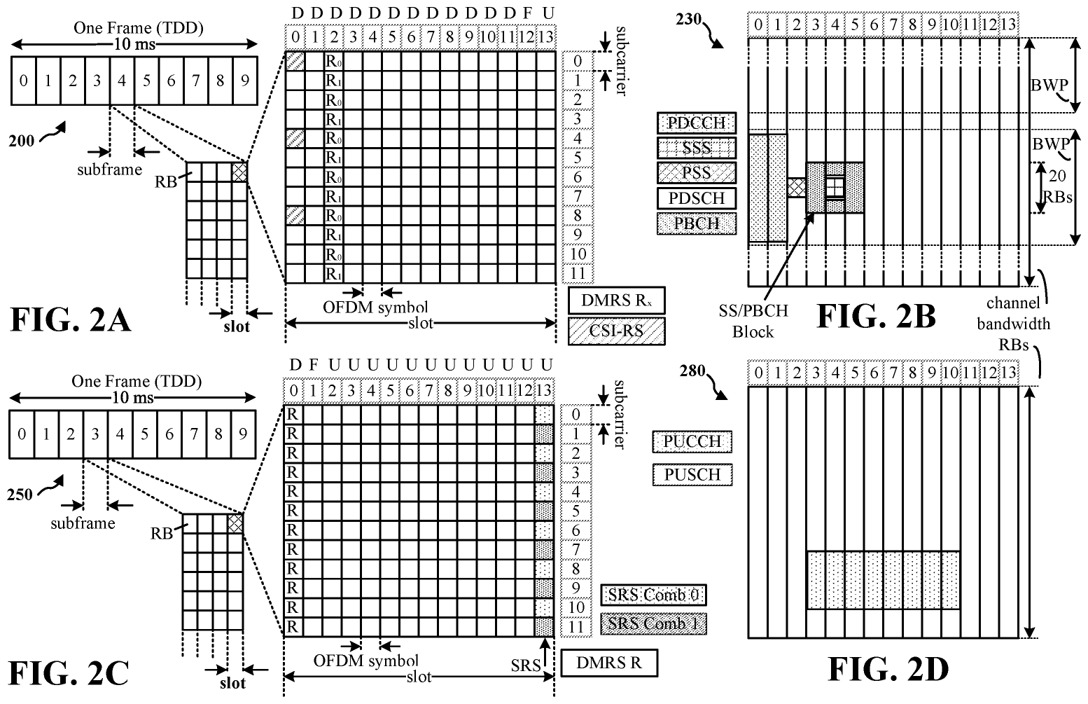

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE may determine a physical cell identifier (PCI). Based on the PCI, the UE may determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIB s), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

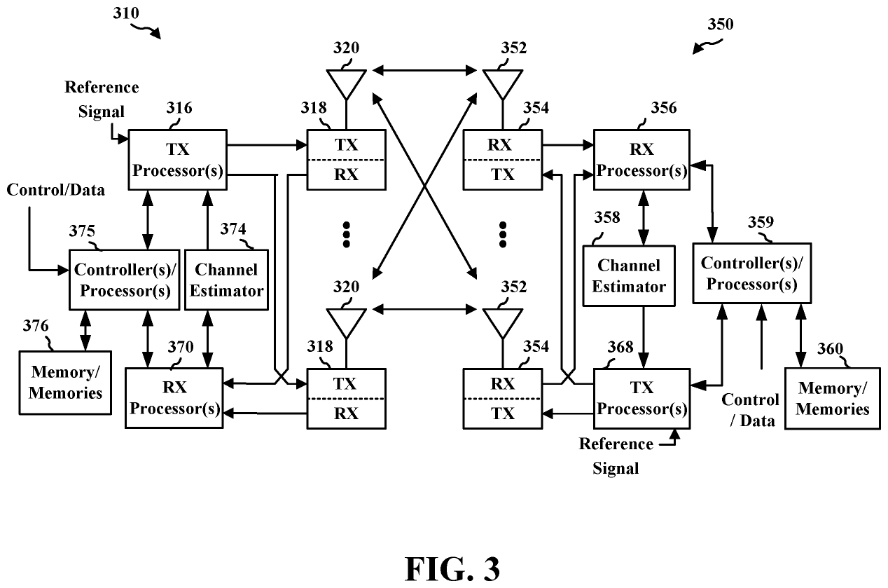

FIG. 3 is a block diagram of a base station 310 in communication with a UE 350 in an access network. In the DL, IP packets from the EPC 160 may be provided to one or more controllers/processors 375. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIB s), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation and coding schemes (MCS) (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 implement layer 1 functionality associated with various signal processing functions. The one or more RX processors 356 may perform spatial processing on the information to recover any spatial streams destined for the UE 350. If multiple spatial streams are destined for the UE 350, they may be combined by the one or more RX processors 356 into a single OFDM symbol stream. The one or more RX processors 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the one or more controllers/processors 359, which implement layer 3 and layer 2 functionality.

The one or more controllers/processors 359 may each be associated with one or more memories 360 that store program codes and data. The one or more memories 360, individually or in any combination, may be referred to as a computer-readable medium. In the UL, the one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with the DL transmission by the base station 310, the one or more controllers/processors 359 provide RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium. In the UL, the one or more controllers/processors 375 provide demultiplexing between transport and logical channels, packet reassembly, deciphering, header decompression, control signal processing to recover IP packets from the UE 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 368, the one or more RX processors 356, and the one or more controllers/processors 359 may be configured to perform aspects in connection with the TRP mode dynamic switching configuration component 198 of FIG. 1.

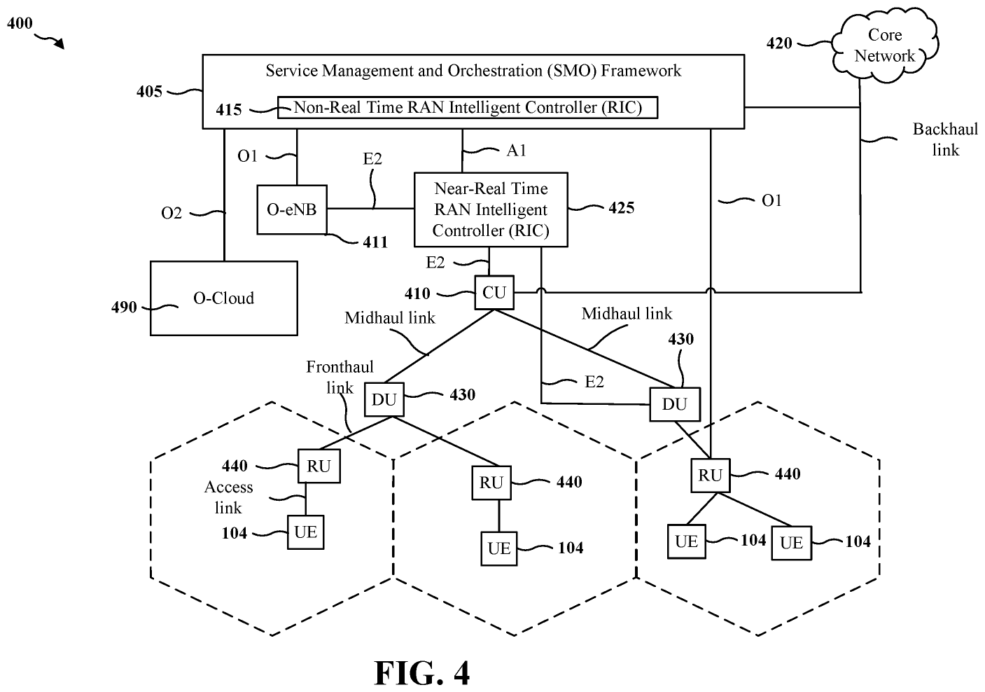

FIG. 4 is a block diagram illustrating an example disaggregated base station 400 architecture. The disaggregated base station 400 architecture may include one or more CUs 410 that may communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440.

Each of the units, e.g., the CUs 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 410. The CU 410 may be configured to handle user plane functionality (e.g., central unit-user plane (CU-UP)), control plane functionality (e.g., central unit-control plane (CU-CP)), or a combination thereof. In some implementations, the CU 410 may be logically split into one or more CU-UP units and one or more CU-CP units. The CU-UP unit may communicate bidirectionally with the CU-CP unit via an interface, such as the E1 interface when implemented in an O-RAN configuration. The CU 410 may be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) may be implemented with an interface configured to communicate signals with other layers (and modules) hosted by the DU 430, or with the control functions hosted by the CU 410.

Lower-layer functionality may be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 may be implemented to handle over the air (OTA) communication with one or more UEs 104. In some implementations, real-time and non-real-time aspects of control and user plane communication with the RU(s) 440 may be controlled by the corresponding DU 430. In some scenarios, this configuration may enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements may include, but are not limited to, CUs 410, DUs 430, RUs 440 and near-RT RICs 425. In some implementations, the SMO framework 405 may communicate with a hardware aspect of a 4G RAN, such as an open eNB (O-eNB) 411, via an O1 interface. Additionally, in some implementations, the SMO Framework 405 may communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via 01) or via creation of RAN management policies (such as A1 policies).

In an aspect of the present disclosure, a transmission configuration indicator or indication (TCI) may be unified for indication of multiple DL and UL TCI states focusing on multi-TRP (mTRP) use case, using a unified TCI framework. In some aspects, the unified TCI framework may facilitate simultaneous multi-panel UL transmission for higher UL throughput and/or reliability, focusing on FR2 (e.g., millimeter wave or higher frequencies) and multi-TRP mode, assuming up to 2 TRPs and up to 2 panels for targeting customer-premises equipment (CPE)/fixed wireless access (FWA)/vehicle/industrial devices. In one example of facilitating simultaneous multi-panel UL transmission, in some aspects, the unified TCI framework may facilitate UL precoding indication for PUSCH, where no new codebook is introduced for multi-panel simultaneous transmission. The total number of data layers may be up to four across all panels and the total number of codewords may be up to two across all panels, considering single DCI and multi-DCI based multi-TRP operation. In another example of facilitating simultaneous multi-panel UL transmission, in some aspects, an UL beam indication for PUCCH/PUSCH, where a unified TCI framework extension is assumed, may consider single DCI and multi-DCI based multi-TRP operation. In this example, for the case of multi-DCI based multi-TRP operation, only PUSCH+PUSCH, or PUCCH+PUCCH is transmitted across two panels in a same component carrier.

There are three types of unified TCI. Type 1 is a Joint TCI state that indicates a common beam for at least one DL channel/RS plus at least one UL channel/RS, including at least a UE-specific or dedicated PDCCH, PDSCH, PUCCH, PUSCH, and CSI-RS. Type 2 is a separate DL TCI state to indicate a common beam for more than one DL channel/RS, including at least a UE-specific or dedicated PDCCH, PDSCH and CSI-RS. Type 3 is a separate UL TCI state to indicate a common beam for more than one UL channel/RS, including at least a UE-specific or dedicated PUCCH, PUSCH.

In some aspects, the unified TCIs may be configured in RRC pools, activated by MAC-CE. The DCI format 1_1 or 1_2 may indicate unified TCI from the activated ones. The indicated unified TCI may be applied to an applicable channel (see Table 1). In some aspects, only 1 unified TCI may be indicated by DCI at a time in sTRP. In other aspects, when unified TCI state framework is extended to mTRP, more than 1 TCI may be indicated by DCI (e.g., 1 indicated TCI per TRP).

TCI state may be applied to the following channels/RSs once activated as shown in Table 1.

TABLE 1
Application of TCI States to Applicable Channels

| | | Optional (may be |
|---|---|---|
| TCI State Type | Mandatory | configured in RRC) |
| Separate DL | UE dedicated PDCCH and | Non-UE dedicated |
| TCI | PDSCH | PDCCH and PDSCH, |
| | | AP CSI-RS for CSI, AP |
| | | CSI RS for BM |
| Separate UL | UE dedicated PUSCH | SRS for CB/NCB/ |
| TCI | (dynamic grant and | Antenna switching |
| | configured grant based) | (AS), AP SRS for BM |
| | and PUCCH | |
| Joint DL and | UE dedicated PDCCH and | Non-UE dedicated |
| UL TCI | PDSCH | PDCCH and PDSCH, |
| | UE dedicated PUSCH | AP CSI-RS for CSI, AP |
| | (dynamic grant and | CSI RS for BM |
| | configured grant based) | SRS for CB/NCB/ |
| | and PUCCH | Antenna switching |
| | | (AS), AP SRS for BM |

In one or more implementations, a DCI of format 1_1 or 1_2 may be used to indicate TCI state with or without scheduling any DL assignment. When the DCI is provided with DL assignment, the TCI field in the DCI may explicitly indicate the TCI. When the DCI is provided without DL assignment, the TCI may be implicitly indicated as follows: 1) a cyclic redundancy check (CRC) of the DCI is scrambled by a configured scheduling radio network temporary identifier (CS-RNTI), and 2) the following fields are set as follows: redundancy version (RV)=all ‘1’s; modulation and coding scheme (MCS)=all ‘1’s; new data indicator (NDI)=0; frequency domain resource assignment (FDRA)=all ‘0’s for FDRA Type 0, or all 1's for FDRA Type 1, or all 0's for dynamic switch; the TCI field (if present) may be used to indicate the TCI state ID; the PDSCH-to-HARQ_feedback timing indicator field (if present) may be used to indicate the time offset from the DCI to its ACK in PUCCH. For type-1 HARQ-ACK codebook, the TDRA field may be used to derive a virtual PDSCH location, which is further used to determine a location for the ACK information in the HARQ-ACK codebook.

Multiple TRPs may be deployed to improve spatial diversity of millimeter wave (mmW) signal reception. In some aspects, the maximum number of TRPs may be up to 2 TRPs. In other aspects, the maximum number of TRPs may be more than 2 TRPs.

In a configuration involving multiple TRPs using multiple DCIs (e.g., mTRP mDCI), each TRP may be associated with a CORESET pool. Each TRP may send its own PDCCH from an associated CORESET to schedule communication from a same TRP. Namely, the DCI from a TRP may schedule the communication from the same TRP. In some aspects, multiple TCI states may be associated with each CORESET pool TRP.

In a configuration involving multiple TRPs using a single DCI (e.g., mTRP sDCI), the DCI may schedule communication from multiple TRPs. When a TCI is activated via MAC-CE, the MAC-CE may map a pair of TCIs, with each TCI originating from a respective TRP, to a TCI codepoint. The DCI may indicate an index of the TCI codepoint for a communication assignment. In some aspects, the pair of beams (each from a TRP) may be used for the communication. In some aspects, the CORESET pool may not be configured, and the UE may or may not determine the association between TRP and TCI.

In an mTRP case, the UE may have 1, 2, . . . , or M indicated TCIs, where M is the number of TRPs. The UE may have 0 or 1 indicated TCI per TRP. When the UE has more than 1 indicated TCI state, the association of channel/resources with the indicated TCI states may be preconfigured or set by predefined rules. In some aspects, the indicated TCI states may be preconfigured by RRC signaling, where each CORESET is associated with 1 or 2 indicated TCI states. In other aspects, the indicated TCI states may be preconfigured by a predefined rule. For example, if the PUCCH/PUSCH is configured with repetition of order N, then for each repetition, the UE may select one out of multiple indicated TCIs by a predefined rule. For example, the first repetition may use the first indicated TCI. In another example, the first repetition may use the TCI from CORESET pool ID0, among others.

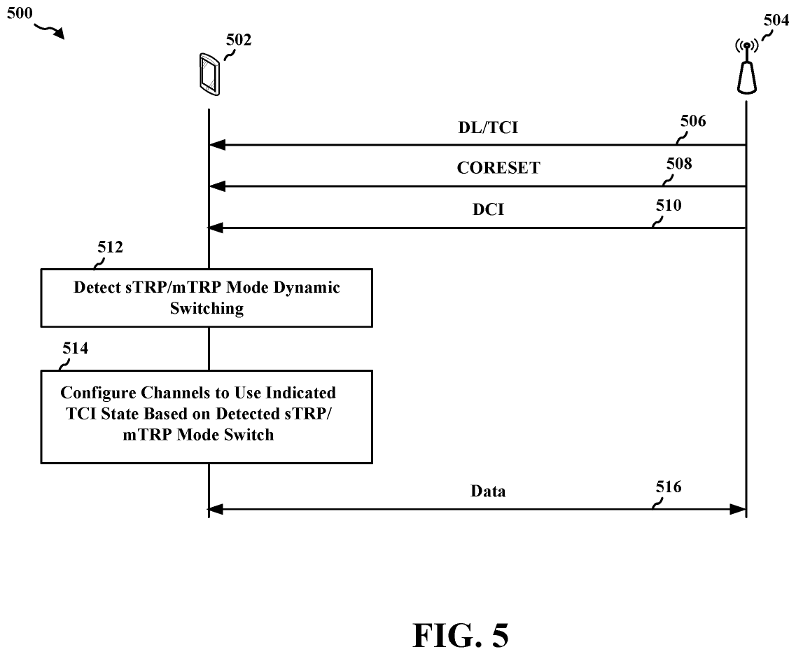

FIG. 5 is a flow diagram 500 of beam selection rule during mTRP/sTRP modes dynamic switching in accordance with an aspect of the present disclosure. Diagram 500 illustrates information received by UE 502 from BS 504. Initially, the UE 502 receives downlink information, such as DL/TCI signal 506, from the BS 504. The UE 502 may also receive CORESET 508 from the BS 504.

Further, the UE 502 may receive DCI 510 from the BS 504. At 512, the UE 502 then detects a sTRP/mTRP modes dynamic switching based on the received DCI 510. At 514, the UE 502 then configures one or more channels that are preconfigured to use a fixed number of indicated TCIs or its preconfigured association with TCIs, based on the detected dynamic switch between the sTRP/mTRP modes. Finally, the UE 502 communicates data 516 with the BS 504 in the one or more channels configured at 514. For example, the UE 502 may receive downlink data in PDCCH or PDSCH from the BS 504 (such as a CORESET or SPS PDSCH), or the UE 502 may transmit uplink data in PUCCH or PUSCH to the BS 504 (such as a CG PUSCH), in a transmission beam associated with a TCI state that the UE 502 and BS 504 selects for the channel communication based on the detected dynamic switch between the sTRP/mTRP modes.

When only a single indicated TCI is indicated to the UE via the DCI 510, the UE is effectively in sTRP mode. On the other hand, when multiple indicated TCIs are indicated to UE via DCI, the UE is in mTRP mode. In some aspects, the indicated TCIs are dynamically updated by DCI, which in effect changes the number of indicated TCIs. Accordingly, the switch between sTRP and mTRP modes is effectively dynamically signaled by DCI.

Certain channels may be preconfigured assuming a fixed number of indicated TCIs (e.g., SPS PDSCH), or its association with TCIs may be preconfigured (e.g., CORESETs). However, when the number of indicated TCI states is dynamically changed, the pre-configuration of those channels is not currently updated. To alleviate this problem during sTRP and mTRP dynamic switch, it would be helpful to define the rules or behavior of the preconfigured channels after a detected change in the number of TRPs.

In one or more implementations, the CORESET 508 may be configured to use N indicated TCIs (e.g., indicated to the UE 502 via the DL/TCI signal 506), where after a new TCI indication via the DCI 510, the UE has M indicated TCIs, where M>N. In this case, the switch occurs from sTRP mode to mTRP mode. In some aspects, the CORESET 508 may still use the N indicated TCIs, which are selected from the newly-indicated M TCIs. The UE 502 may select which indicated TCI to use based on a predefined rule. For example, the UE 502 may be configured to use a single indicated TCI, and the CORESET 508 may be associated with a single TCI by pre-configuration. When the UE 502 receives the DCI 510, the UE 502 is indicated with two indicated TCIs. In some implementations, the CORESET 508 may use the indicated TCI corresponding to a CORESET pool identifier (if the CORESET pool ID is configured). In other implementations, the CORESET 508 may use the indicated TCI corresponding to a smallest TRP identifier.

In one or more implementations, the CORESET 508 may be configured to use N indicated TCIs (e.g., indicated to the UE 502 via the DL/TCI signal 506), where after a new TCI indication via the DCI 510, the UE has M indicated TCIs, where M<N. In this case, the switch occurs from mTRP mode to sTRP mode. In some aspects, the CORESET 508 may be deactivated until a next configuration. In other aspects, the CORESET 508 may use the newly-indicated M TCIs. For example, the CORESET 508 may be associated with two indicated TCIs (e.g., TCI1 and TCI2) by pre-configuration. The DCI 510 received by the UE 502 may indicate that a single TCI that corresponds to one of the preconfigured indicated TCIs (e.g., TCI2) is active for the UE 502. Accordingly, the CORESET 508 may use the newly-indicated TCI2.

Thus, for CORESET sTRP/mTRP dynamic switching, a predefined rule for configuring the preconfigured channels may indicate that if two joint/DL TCI states are first indicated to the UE via the DL/TCI signal 506, and the DCI 510 later indicates to the UE 502 that a single joint/DL TCI state is indicated, then CORESETs (e.g., CORESET 508) configured to share one or both indicated joint/DL TCI states may use the single indicated joint/DL TCI state.

In one or more implementations, the preconfigured channels may be SPS-PDSCH, which may be configured to use N indicated TCIs (e.g., indicated to the UE 502 via the DL/TCI signal 506), where after a new TCI indication via the DCI 510, the UE has M indicated TCIs, where M>N. In this case, the switch occurs from sTRP mode to mTRP mode. In some aspects, the SPS PDSCH may still use N indicated TCIs, which are selected from the newly-indicated M TCIs. The UE 502 may select which indicated TCI to use based on a predefined rule. For example, the SPS PDSCH may be configured to use a single indicated TCI. When the UE 502 receives the DCI 510, the UE 502 is indicated with two indicated TCIs. In some implementations, the SPS PDSCH may use the indicated TCI corresponding to a smallest TRP identifier.

In one or more implementations, the SPS PDSCH may be configured to use N indicated TCIs (e.g., indicated to the UE 502 via the DL/TCI signal 506), where after a new TCI indication via the DCI 510, the UE has M indicated TCIs, where M<N. In this case, the switch occurs from mTRP mode to sTRP mode. In some aspects, the SPS PDSCH may be deactivated until a next configuration. In other aspects, the SPS PDSCH may use the newly-indicated M TCIs. In still other aspects, the SPS PDSCH may still use the originally configured TCIs. Which option to use may depend on SPS PDSCH configuration. For example, if the SPS PDSCH is configured for time division multiplexing (TDM) or frequency division multiplexing (FDM), then the SPS PDSCH being configured to use a fewer number of indicated TCIs than its original configuration is acceptable. In another example, if the SPS PDSCH is configured for spatial division multiplexing (SDM), then a minimum number of TCI states may be based on the number of data layers of the UE. In some aspects, the UE 502 may disable SPS PDSCH if the number of TCI states is smaller than the number of data layers.

Thus, for SPS PDSCH sTRP/mTRP dynamic switching, a predefined rule for configuring the preconfigured channels may indicate that if two TCI states are first indicated to the UE via the DL/TCI signal 506, and the DCI 510 later indicates to the UE 502 that a single joint/DL TCI state is instead indicated, then either the SPS PDSCH may use the later indicated joint/DL TCI state or the SPS PDSCH may be disabled. For example, for FDM/TDM based SPS PDSCH that is originally activated for two indicated joint/DL TCI states, all PDSCH occasions of the SPS PDSCH may use the later indicated single joint/DL TCI state. In another example, for SDM based SPS PDSCH that is originally activated for two indicated joint/DL TCI states, the corresponding SPS PDSCH may be implicitly disabled after the application time of the later indicated single joint/DL TCI state. In still another example, for sTRP based SPS PDSCH that is originally activated for one of the two indicated joint/DL TCI states, all PDSCH occasions of the SPS may use the later indicated single joint/DL TCI state.

Similarly, for PUSCH sTRP/mTRP dynamic switching, a predefined rule for configuring the preconfigured channels may indicate that if two TCI states are first indicated to the UE via the DL/TCI signal 506, and the DCI 510 may indicates to the UE 502 that a single TCI state is instead indicated, then either the CG PUSCH may use the single indicated TCI state or the CG PUSCH may be disabled. For example, for PUSCH repetitions with Type1 CG and Type 2 CG that are originally configured (or activated) for two indicated TCI states, all PUSCH repetitions may use the later indicated single TCI state. In another example, for SDM based PUSCH repetitions with Type 1 CG and Type 2 CG that are originally configured (or activated) for two indicated TCI states, the corresponding CG may be implicitly disabled after the application time of the later indicated single TCI state.

In mTRP mode for PUSCH repetitions with Type 1 CG, the existing sounding reference signal (SRS) resource indicators (SRIs) as well as other parameters configured in a configured grant configuration parameter (referred to as the “configuredGrantConfig” parameter) may be used to inform the UE 502 which indicated TCI state(s) are applied to PUSCH. Specifically, if two SRIs and transmit precoder matrix indicators (TPMIs) are provided and if two joint/UL TCI states are indicated in the DCI 510, the PUSCH repetition(s) associated with one SRS resource set may use one of the two indicated TCI states (e.g., the PUSCH repetition(s) associated with the 1st SRS resource set may use the 1st indicated TCI state, and the PUSCH repetition(s) associated with the 2nd SRS resource set may use the 2nd indicated TCI state). If there is only one set of SRI, TPMI, and power control (PC) parameters in the configuredGrantConfig parameter and if two joint/UL TCI states are indicated in the DCI 510, then all PUSCH repetitions may use or be associated with one of the two indicated TCI states (e.g., the 1st indicated TCI state for all PUSCH repetitions). The PC parameters may include, for example, a path loss reference index (pathlossReferenceIndex), an alpha value for PUSCH (p0-PUSCH-Alpha), and a power control loop parameter (powerControlLoopToUse).

Thus, for PUSCH repetitions with Type 1 CG, a predefined rule for configuring the preconfigured channels may indicate that the existing SRI(s) configured in the configuredGrantConfig parameter may be reused to inform which TCI state(s) are applied to PUSCH. In one or more implementations, if two SRIs and two precoding information are provided, the PUSCH repetition(s) associated with one SRS resource set may use one of the two indicated TCI states if two joint/UL TCI states are indicated (e.g., 1st indicated TCI state is used for PUSCH repetition(s) associated with 1st SRS resource set). In one or more implementations, if the configuredGrantConfig parameter contains only one value for each of pathlossReferenceIndex, p0-PUSCH-Alpha, powerControlLoopToUse, srs-ResourceIndicator, and precodingAndNumberOfLayers (for CB), all PUSCH repetitions may be associated with only one of the two indicated TCI states if two joint/UL TCI states are indicated (e.g., 1st indicated TCI state is used for all repetitions).

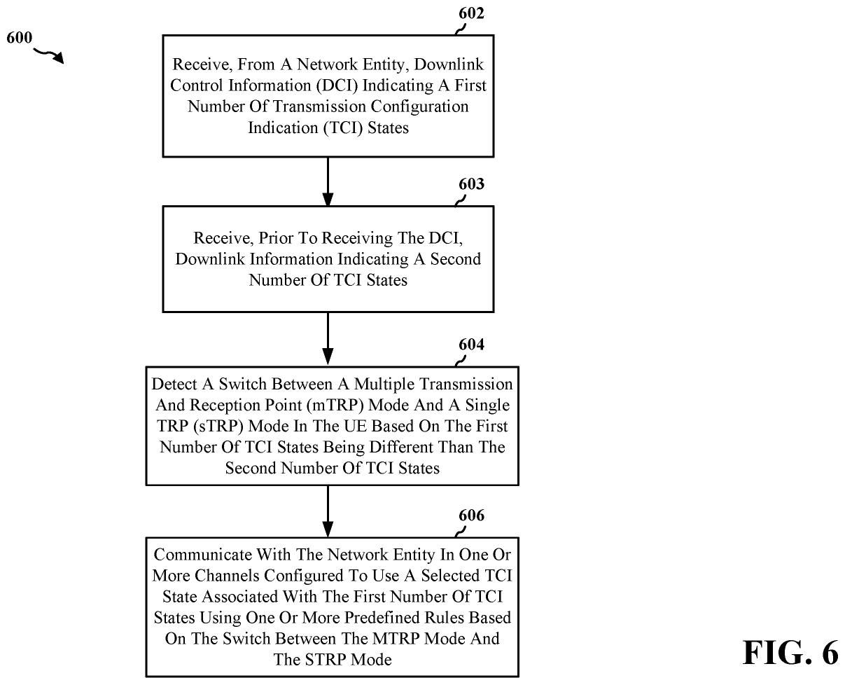

FIG. 6 is a flowchart 600 of a method of wireless communication. The method may be performed by a UE (e.g., the UE 104, 502; the UE 350; the apparatus 802). As illustrated, the flowchart 600 includes a number of enumerated operations, but aspects of the flowchart 600 may include additional operations before, after, and in between the enumerated operations. In some aspects, one or more of the enumerated operations may be omitted or performed in a different order. According to different aspects, one or more of the illustrated operations may be transposed and/or contemporaneously performed.

At 602, the UE may receive, from a network entity, downlink control information indicating a first number of transmission configuration indication states, such as DCI 510. In some aspects, the UE may receive a CORESET that is preconfigured to use a second number of TCI states.

At 603, the UE may receive, prior to receiving the downlink control information at 602, downlink information indicating the second number of TCI states, such as DL/TCI signal 506.

At 604, the UE may detect a switch between a mTRP mode and a sTRP mode in the UE based on the first number of TCI states indicated in the DCI being different than the second number of TCI states, such as in response to identifying that DCI 510 indicates one TCI state while prior indicated DL/TCI signal 506 indicates multiple TCI states, or vice-versa. In some aspects, the first number of TCI states includes a single TCI state in the sTRP mode of the UE. In other aspects, the first number of TCI states includes a plurality of TCI states in the mTRP mode of the UE.

Finally, at 606, the UE may communicate with the network entity in one or more channels configured to use a selected TCI state associated with the first number of TCI states using one or more predefined rules based on the switch between the mTRP mode and the sTRP mode. In some aspects, the one or more channels are preconfigured to use a fixed number of TCI states prior to the switch between the mTRP mode and the sTRP mode.

In some aspects, the one or more channels may include a PDCCH associated with a CORESET that is preconfigured to use the second number of TCI states, and the first number of TCI states indicated in the DCI is greater than the second number of TCI states. Accordingly, the UE may detect the switch from the sTRP mode to the mTRP mode for CORESET sTRP/mTRP dynamic switching based on the second number of TCI states being less than the first number of TCI states. In some aspects, the one or more predefined rules indicate the CORESET is configured to switch an associated TCI state from a TCI state associated with the second number of TCI states to the selected TCI state associated with the first number of TCI states based on the switch between the mTRP mode and the sTRP mode. In some aspects, the one or more predefined rules further indicate the CORESET is configured to use the selected TCI state that corresponds to a smallest TRP identifier of TRP identifiers associated with the first number of TCI states. In other aspects, the one or more predefined rules further indicate the CORESET is configured to use the selected TCI state that corresponds to a CORESET pool identifier in response to the CORESET pool identifier being configured for the CORESET.

In other aspects, the first number of TCI states indicated in the DCI is less than the second number of TCI states. Accordingly, the UE may detect the switch from the mTRP mode to the sTRP mode for CORESET sTRP/mTRP dynamic switching based on the second number of TCI states being greater than the first number of TCI states. In some aspects, the one or more predefined rules further indicate the CORESET is configured to become disabled after an application time of the selected TCI state until a next downlink control signaling indicates another switch between the mTRP mode and the sTRP mode in the UE. In other aspects, the one or more predefined rules further indicate the CORESET is configured to use the selected TCI state from the first number of TCI states that is active for the UE.

In some aspects, the one or more channels includes a semi-persistent scheduling (SPS) physical downlink shared channel (PDSCH) that is preconfigured to use the second number of TCI states, in which the one or more predefined rules indicates the SPS PDSCH is configured to switch an associated TCI state from a TCI state associated with the second number of TCI states to the selected TCI state associated with the first number of TCI states based on the switch between the mTRP mode and the sTRP mode.

In some aspects, the first number of TCI states indicated in the DCI is greater than the second number of TCI states, in which the UE may detect the switch from the sTRP mode to the mTRP mode for PDSCH sTRP/mTRP dynamic switching based on the second number of TCI states being less than the first number of TCI states. In some aspects, the one or more predefined rules further indicate the SPS PDSCH is configured to use the selected TCI state that corresponds to a CORESET pool identifier associated with the DCI activating the SPS PDSCH in response to the CORESET pool identifier being configured. In other aspects, the one or more predefined rules further indicate the SPS PDSCH is configured to use the selected TCI state that corresponds to a smallest TRP identifier of TRP identifiers associated with the first number of TCI states. In still other aspects, the one or more predefined rules further indicates the SPS PDSCH is configured to use the selected TCI state that corresponds to a smallest TCI identifier of TCIs associated with the first number of TCI states in response to the DCI indicating the TCIs associated with the first number of TCI states that are from a same CORESET pool.

In some aspects, the first number of TCI states indicated in the DCI is less than the second number of TCI states, in which the UE may detect the switch from the mTRP mode to the sTRP mode for PDSCH sTRP/mTRP dynamic switching based on the second number of TCI states being greater than the first number of TCI states. In some aspects, the one or more predefined rules further indicate the SPS PDSCH is configured to become implicitly disabled after an application time of the selected TCI state until a next downlink control signaling indicates another switch between the mTRP mode and the sTRP mode in the UE in response to the SPS PDSCH being configured for spatial division multiplexing (SDM) and the first number of TCI states indicated in the DCI being less than a number of data layers of the UE. In some aspects, the one or more predefined rules further indicate the SPS PDSCH is configured to use the selected TCI state associated with the first number of TCI states that are active for the UE in response to the SPS PDSCH being configured for time division multiplexing (TDM) or frequency division multiplexing (FDM). In some aspects, the one or more predefined rules further indicate the SPS PDSCH is configured to use a TCI state associated with the second number of TCI states that are preconfigured to the UE.

In one or more implementations, the one or more channels includes a configured grant (CG) physical uplink shared channel (PUSCH) that is preconfigured to use the second number of TCI states, where the one or more predefined rules indicate the CG PUSCH is configured to switch an associated TCI state from a TCI state associated with the second number of TCI states to the selected TCI state associated with the first number of TCI states based on the switch between the mTRP mode and the sTRP mode. In some aspects, the first number of TCI states indicated in the DCI is less than the second number of TCI states, in which the UE may detect the switch from the mTRP mode to the sTRP mode for PUSCH sTRP/mTRP dynamic switching based on the second number of TCI states being greater than the first number of TCI states. In some aspects, the one or more predefined rules further indicate the CG PUSCH is configured to become implicitly disabled after an application time of the selected TCI state until a next downlink control signaling indicates another switch between the mTRP mode and the sTRP mode in the UE in response to the PUSCH with Type 1 CG or Type 2 CG being configured for spatial division multiplexing (SDM). In other aspects, the one or more predefined rules further indicate each of a plurality of PUSCH repetitions with Type 1 CG or Type 2 CG is configured to use the selected TCI state associated with the first number of TCI states that are active for the UE in response to the CG PUSCH being configured for time division multiplexing (TDM) or frequency division multiplexing (FDM).

In one or more implementations, the UE may be further configured to receive, from the network entity, a configuration indicating one or more sounding reference signal (SRS) resource indicators (SRIs), where the one or more SRIs inform the UE that the selected TCI state is applied to Type 1 CG PUSCH repetitions in the CG PUSCH. In some aspects, the selected TCI state associated with the first number of TCI states is applied to the Type 1 CG PUSCH repetitions associated with an SRS resource set in response to the configuration indicating a plurality of SRIs and the first number of TCI states indicating a plurality of TCI states. In other aspects, the selected TCI state associated with the first number of TCI states is applied to the Type 1 CG PUSCH repetitions in response to the configuration indicating a single SRI and the first number of TCI states indicating a plurality of TCI states.

In one or more implementations, in response to the DCI being received on a first component carrier, the DCI indicating a scheduled physical downlink shared channel (PDSCH) on a second component carrier different than the first component carrier, the selected TCI state being associated with a non-serving cell, and a scheduling time offset between reception of the DCI and the scheduled PDSCH being smaller than a time offset threshold, the UE may receive, in a scheduling slot of the scheduled PDSCH, a medium access control (MAC) control element (MAC-CE) indicating a plurality of TCI identifiers in a PDSCH TCI list activated by the MAC-CE, in which the selected TCI state corresponds to a lowest TCI identifier of the plurality of TCI identifiers for an active bandwidth part (BWP) of the second component carrier with the scheduled PDSCH, and determine a quasi-co-location (QCL) assumption for the scheduled PDSCH based on the selected TCI state.

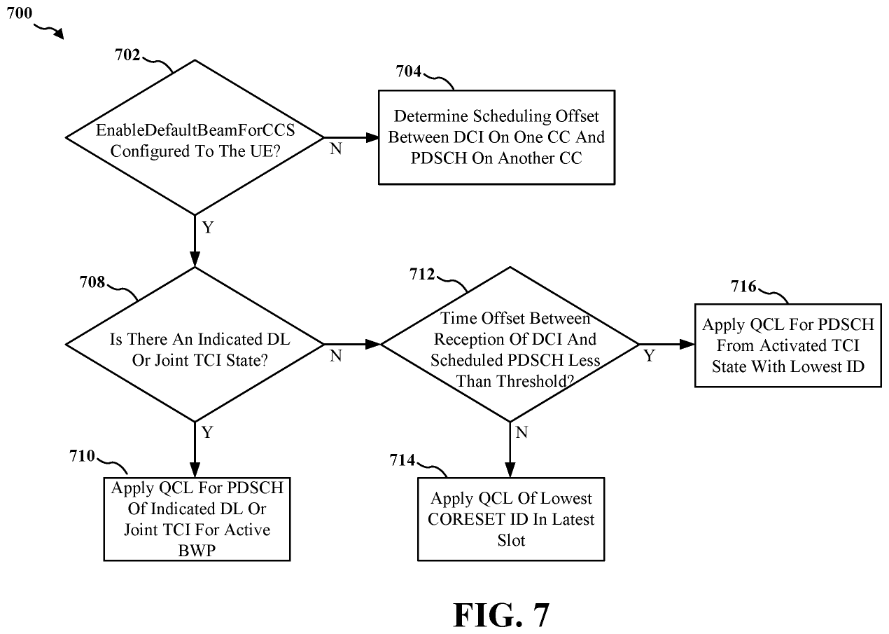

FIG. 7 is a flowchart 700 illustrating an example configuration of a default beam for receiving information in accordance with various aspects of the present disclosure. At 702, the UE 104 determines if a default beam selection for cross carrier scheduling parameter, e.g., a parameter named “enableDefaultBeamForCCS” is received and/or configured to the UE 104. If the parameter is not received and/or configured, the UE may determine a scheduling offset between the DCI received on one CC and PDSCH received on another CC as shown in block 704.

If enableDefaultBeamForCCS is received and/or configured to the UE 104, the UE 104 determines, at block 708, whether there is an indicated DL TCI or indicated Joint TCI (for DL and UL). If there is an indicated DL TCI or indicated Joint TCI for reception of the PDSCH, then the quasi-co location (QCL) of the indicated DL TCI or indicated Joint TCI for the active BWP is applied by the UE 104 for reception of the PDSCH as shown in block 710.

If there is not an indicated DL TCI or indicated Joint TCI as determined in block 708, the UE determines, at 712, if a scheduling time offset between reception of a DCI and the scheduled PDSCH is less than a threshold. In an aspect of the present disclosure, the UE 104 may receive a DCI on a first CC and a scheduled PDSCH on a second CC. The determined scheduling time offset may be the minimum amount of time the UE has to wait between the reception of the DCI on the first CC and the PDSCH on the second CC. When the UE 104 is configured with enableDefaultBeamForCCS, the scheduling time offset between the last symbol of the PDCCH carrying the triggering DCI on one CC and the first symbol of the scheduled PDSCH on another CC may be smaller than a predetermined time offset (or the threshold). If the scheduling time offset between reception of the DCI and the scheduled PDSCH is less than the threshold, then the UE 104 may apply the QCL assumption for PDSCH from the activated TCI state with the lowest ID for reception of the scheduled PDSCH, as shown in block 716.

If there are no indicated DL TCI or indicated Joint TCI as determined in block 708, and the scheduling time offset between the reception of the DCI and scheduled PDSCH is not smaller than the threshold, as determined by block 712, then the UE 104 may apply the QCL assumption of the lowest CORESET identifier in a latest slot, as applied at block 714, for reception of the PDSCH; however, other TCI states may be used without departing from the scope of the present disclosure.

In one or more implementations, a scheduling offset that is less than a threshold that corresponds to a QCL time duration parameter (e.g., the “timeDurationForQCL” parameter) may trigger a configuration rule regardless of any configuration of a follow unified TCI state parameter (e.g., the “followUnifiedTCIstate” parameter). In some implementations of this configuration rule, if the indicated TCI is associated with a physical cell identity (PCI) that is different from a serving cell PCI (e.g., inter-cell), then the UE may be configured to apply a default QCL assumption for both a non-UE dedicated PDSCH and a UE dedicated PDSCH (e.g., QCL assumption of a lowest CORESET ID in a latest slot). In some implementations of this configuration rule, if the QCL-TypeD property for one or more default beams in a slot for component carriers in a band are different, then the default beam for the component carrier with a lowest identifier (ID) is prioritized (e.g., the default beam for the component carrier with the lowest ID is applied to all the component carriers in a band). In one or more other implementations of this configuration rule, if the indicated TCI is associated with serving cell PCI (e.g., intra-cell), the UE may use indicated TCI for both UE-dedicated/non-UE-dedicated PDSCH (e.g., UE does not consider default QCL). In some aspects, the same approach may be applied to default beam for aperiodic CSI-RS.

Thus, the aforementioned configuration rule indicates that when the scheduling time offset between DCI and its scheduling PDSCH is less than a threshold, and if the indicated TCI is associated with a non-serving cell, then the UE may use a default beam as the beam of the lowest ID CORESET in the latest monitored slot. Alternatively if the indicated TCI is associated with a serving cell, then the UE may use a default beam as the current indicated TCI.

However, for cross-carrier scheduling, the DCI in a first component carrier, denoted as CC1, may schedule a PDSCH in a second component carrier, denoted as CC2, where CC2 has no configured CORESET. If the indicated TCI in CC2 is associated with a non-serving cell, the aforementioned configuration rule may not apply because CC2 is not configured with a CORESET.

In an example of such cross-carrier scheduling case, the base station (or network entity) may typically schedule a PDSCH later than the threshold. Namely, the UE may not expect the network to schedule a PDSCH whose scheduling time offset is smaller than the threshold.

In another example of such cross-carrier scheduling case, if the indicated TCI is not associated with a serving cell, the default TCI may be the TCI state corresponding to the lowest TCI ID in the PDSCH TCI list activated by MAC-CE in the scheduling PDSCH slot. In still another example of such cross-carrier scheduling case, the default beam may usually be the indicated TCI in the scheduling PDSCH slot.

When the UE is configured with enableDefaultBeamForCCS (see Y port or yes branch of block 702) and is not indicated with DLorJointTCIState for the active BWP of the component carrier with the scheduled PDSCH (see N port or no branch of block 708), and if the scheduling time offset between the reception of the DL DCI and the corresponding PDSCH is lesser than a threshold (see Y port or yes branch of block 712) as defined by the “timeDurationForQCL” parameter, or if the DL DCI does not have a TCI field present (not shown), then the UE may obtain its QCL assumption for the scheduled PDSCH from the activated TCI state with the lowest ID applicable to PDSCH in the active BWP of the scheduled cell (see block 716).

In some implementations, when the UE is configured with enableDefaultBeamForCCS and is indicated with DLorJointTCIState for the active BWP of the component carrier with the scheduled PDSCH, UE does not expect the offset between the reception of the DL DCI and the corresponding PDSCH to be lesser than the threshold “timeDurationForQCL,” nor does the DL DCI contain the TCI field.

In some implementations, when the UE is configured with enableDefaultBeamForCCS and is indicated with DLorJointTCIState for the active BWP of the component carrier with the scheduled PDSCH, if the offset between the reception of the DL DCI and the corresponding PDSCH is less than the threshold timeDurationForQCL, or if the DL DCI does not have the TCI field present, the UE may obtain its QCL assumption for the scheduled PDSCH based on the activated TCI of the lowest ID for the active BWP of the component carrier with the scheduled PDSCH.

When the UE is configured with enableDefaultBeamForCCS and is not indicated with DLorJointTCIState for the active BWP of the component carrier with the scheduled PDSCH, if the scheduling time offset between the reception of the DL DCI and the corresponding PDSCH is less than the threshold “timeDurationForQCL,” or if the DL DCI does not have the TCI field present, the UE obtains its QCL assumption for the scheduled PDSCH from the activated TCI state with the lowest ID applicable to PDSCH in the active BWP of the scheduled cell.

In some implementations, when the UE is configured with enableDefaultBeamForCCS and is indicated with DLorJointTCIState for the active BWP of the component carrier with the scheduled PDSCH, if the offset between the reception of the DL DCI and the corresponding PDSCH is less than the threshold “timeDurationForQCL,” or if the DL DCI does not have the TCI field present, the UE may obtain its QCL assumption for the scheduled PDSCH based on the indicated DLorJointTCIState for the active BWP of the component carrier with the scheduled PDSCH.

In some implementations, UE may be configured to receive downlink data using multiple TCI states from one or more TRPs. The downlink data may contain multiple MIMO layers, which may be jointly pre-coded across the multiple TCIs in the manner of joint coherent transmission (CJT). In some examples, the TCI states for CJT operation may be TCI states configured for single frequency network (SFN) mode. In an example, the maximum number of the TCI states for CJT may be up to a value defined by a UE capability or configured by the network at the UE (e.g., as an RRC parameter). In some aspects, to determine the precoders used for CJT, the base station may configure the UE to receive CSI-RS, derive a CSI report based on a predefined codebook, and send the CSI report based on a CSI-RS measurement. The predefined codebook may be based on existing codebooks defined in legacy standards for non-CJT operations. In some aspects, the predefined codebook may be a Type II codebook for CJT mTRP, which may be an extension based on an enhanced Type-II regular codebook, a further-enhanced Type-II port selection (PS) codebook, or a codebook dedicated for CJT operation. The number of TRPs in the mTRP mode may at least include a number (NTRP)=[1, 2, 3, 4]. In some aspects, the UE may report its UE capability to the network based on which codebook(s) the UE supports to derive the CSI report for CJT operations.

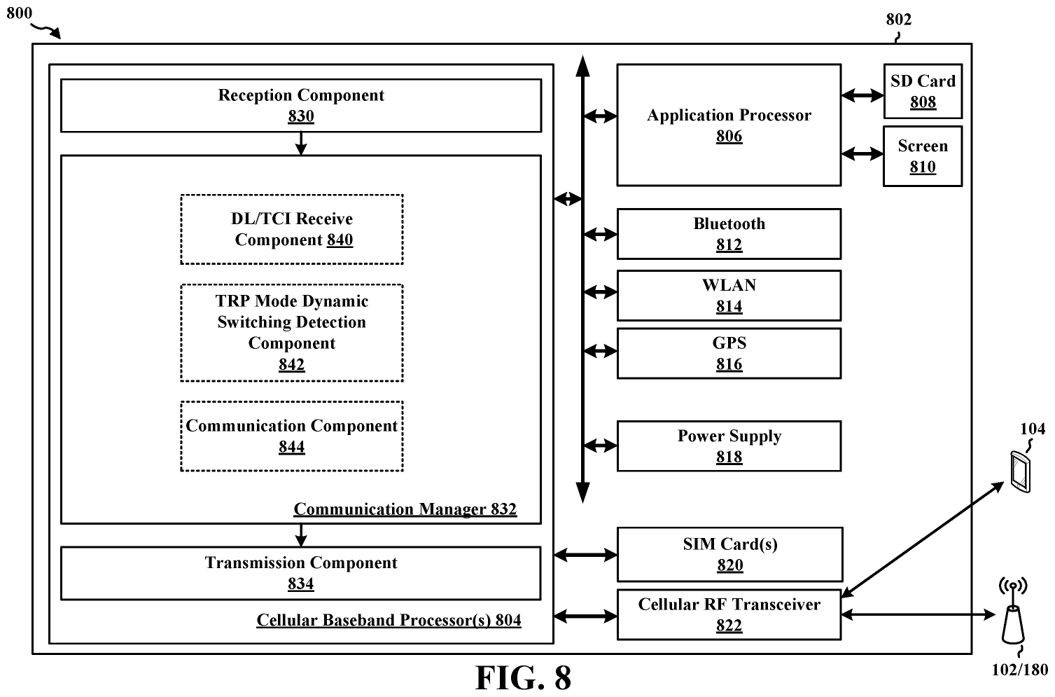

FIG. 8 is a diagram 800 illustrating an example of a hardware implementation for an apparatus 802. The apparatus 802 is a UE and includes one or more cellular baseband processors 804 (also referred to as a modem) coupled to a cellular RF transceiver 822 and one or more subscriber identity modules (SIM) cards 820, an application processor 806 coupled to a secure digital (SD) card 808 and a screen 810, a Bluetooth module 812, a wireless local area network (WLAN) module 814, a Global Positioning System (GPS) module 816, and a power supply 818. The one or more cellular baseband processors 804 communicate through the cellular RF transceiver 822 with the UE 104 and/or BS 102/180. The one or more cellular baseband processors 804 may each include a computer-readable medium/one or more memories. The computer-readable medium/one or more memories may be non-transitory. The one or more cellular baseband processors 804 are responsible for general processing, including the execution of software stored on the computer-readable medium/one or more memories individually or in combination. The software, when executed by the one or more cellular baseband processors 804, causes the one or more cellular baseband processors 804 to, individually or in combination, perform the various functions described supra. The computer-readable medium/one or more memories may also be used individually or in combination for storing data that is manipulated by the one or more cellular baseband processors 804 when executing software. The one or more cellular baseband processors 804 individually or in combination further include a reception component 830, a communication manager 832, and a transmission component 834. The communication manager 832 includes the one or more illustrated components. The components within the communication manager 832 may be stored in the computer-readable medium/one or more memories and/or configured as hardware within the one or more cellular baseband processors 804. The one or more cellular baseband processors 804 may be components of the UE 350 and may individually or in combination include the one or more memories 360 and/or at least one of the one or more TX processors 368, at least one of the one or more RX processors 356, and at least one of the one or more controllers/processors 359. In one configuration, the apparatus 802 may be a modem chip and include just the one or more baseband processors 804, and in another configuration, the apparatus 802 may be the entire UE (e.g., see 350 of FIG. 3) and include the aforediscussed additional modules of the apparatus 802.

The communication manager 832 includes a DL/TCI receive component 840 that receives input in the form of DL/TCI information and is configured to receive, from a network entity via the reception component 830, downlink control information (DCI) that includes DL/TCI information indicating a first number of TCI states, e.g., as described in connection with 602, and prior to receiving the DCI, downlink information indicating a second number of TCI states, e.g., as described in connection with 603. The communication manager 832 includes a TRP mode dynamic switching detection component 842 that is configured to detect a dynamic switch between a multiple transmission and reception point (mTRP) mode and a single TRP (sTRP) mode in the UE based on the first number of TCI states being different than the second number of TCI states, e.g., as described in connection with 604. The communication manager 832 further includes a communication component 844 that is configured to communicate with the network entity in one or more channels configured to use a selected TCI state associated with the first number of TCI states using one or more predefined rules based on the switch between the mTRP mode and the sTRP mode, e.g., as described in connection with 606.

The apparatus may include additional components that perform each of the blocks of the algorithm in the aforementioned flowcharts of FIGS. 6 and 7. As such, each block in the aforementioned flowcharts of FIGS. 6 and 7 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 802, and in particular the one or more cellular baseband processors 804, includes means for receiving, from a network entity, downlink control information (DCI) indicating a first number of transmission configuration indication (TCI) states. The apparatus 802 also includes means for detecting a switch between a multiple transmission and reception point (mTRP) mode and a single TRP (sTRP) mode in the UE based on the first number of TCI states being different than a second number of TCI states which were previously received by the UE. The apparatus 802 also includes means for communicating with the network entity in one or more channels configured to use a selected TCI state associated with the first number of TCI states using one or more predefined rules based on the switch between the mTRP mode and the sTRP mode. The aforementioned means may be one or more of the aforementioned components of the apparatus 802 configured to perform the functions recited by the aforementioned means. As described supra, the apparatus 802 may include the one or more TX Processors 368, the one or more RX Processors 356, and the one or more controllers/processors 359. As such, in one configuration, the aforementioned means may be at least one of the one or more TX Processors 368, at least one of the one or more RX Processors 356, or at least one of the one or more controllers/processors 359, individually or in any combination configured to perform the functions recited by the aforementioned means.

The following examples are illustrative only and may be combined with aspects of other aspects or teachings described herein, without limitation.

Clause 1. An apparatus for wireless communication at a user equipment (UE), comprising: one or more memories; and one or more processors each communicatively coupled with at least one of the one or more memories, the one or more processors, individually or in any combination, operable to cause the apparatus to: receive, from a network entity, downlink control information (DCI) indicating a first number of transmission configuration indication (TCI) states; detect a switch between a multiple transmission and reception point (mTRP) mode and a single TRP (sTRP) mode in the UE based on the first number of TCI states being different than a second number of TCI states which were previously received by the UE; and communicate with the network entity in one or more channels configured to use a selected TCI state associated with the first number of TCI states using one or more predefined rules based on the switch between the mTRP mode and the sTRP mode.

Clause 2. The apparatus of clause 1, wherein the first number of TCI states includes a single TCI state in the sTRP mode of the UE and a plurality of TCI states in the mTRP mode of the UE.

Clause 3. The apparatus of clause 1 or 2, wherein the one or more channels includes a physical downlink control channel (PDCCH) associated with a control resource set (CORESET) that is preconfigured to use the second number of TCI states, and the one or more predefined rules indicate the CORESET is configured to switch an associated TCI state from a TCI state associated with the second number of TCI states to the selected TCI state associated with the first number of TCI states based on the switch between the mTRP mode and the sTRP mode.

Clause 4. The apparatus of clause 3, wherein the first number of TCI states indicated in the DCI is greater than the second number of TCI states, and the one or more processors, individually or in combination, are further operable to cause the apparatus to detect the switch from the sTRP mode to the mTRP mode based on the second number of TCI states being less than the first number of TCI states.

Clause 5. The apparatus of clause 4, wherein the one or more predefined rules further indicate the CORESET is configured to use the selected TCI state that corresponds to a smallest TRP identifier of TRP identifiers associated with the first number of TCI states.

Clause 6. The apparatus of clause 4 or clause 5, wherein the one or more predefined rules further indicate the CORESET is configured to use the selected TCI state that corresponds to a CORESET pool identifier in response to the CORESET pool identifier being configured for the CORESET.

Clause 7. The apparatus of clause 3, wherein the first number of TCI states indicated in the DCI is less than the second number of TCI states, and the one or more processors, individually or in combination, are further operable to cause the apparatus to detect the switch from the mTRP mode to the sTRP mode based on the second number of TCI states being greater than the first number of TCI states.

Clause 8. The apparatus of clause 7, wherein the one or more predefined rules further indicate the CORESET is configured to become disabled after an application time of the selected TCI state until a next downlink control signaling indicates another switch between the mTRP mode and the sTRP mode in the UE.

Clause 9. The apparatus of clause 7 or clause 8, wherein the one or more predefined rules further indicate the CORESET is configured to use the selected TCI state from the first number of TCI states that is active for the UE.

Clause 10. The apparatus of any of clauses 1 to 9, wherein the one or more channels includes a semi-persistent scheduling (SPS) physical downlink shared channel (PDSCH) or a configured grant (CG) physical uplink shared channel (PUSCH) that is preconfigured to use the second number of TCI states, and the one or more predefined rules indicate the SPS PDSCH or the CG PUSCH is configured to switch an associated TCI state from a TCI state associated with the second number of TCI states to the selected TCI state associated with the first number of TCI states based on the switch between the mTRP mode and the sTRP mode.

Clause 11. The apparatus of clause 10, wherein the first number of TCI states indicated in the DCI is greater than the second number of TCI states, and the one or more processors, individually or in combination, are further operable to cause the apparatus to detect the switch from the sTRP mode to the mTRP mode based on the second number of TCI states being less than the first number of TCI states.

Clause 12. The apparatus of clause 11, wherein the one or more predefined rules further indicate the SPS PDSCH is configured to use the selected TCI state that corresponds to a control resource set (CORESET) pool identifier associated with the DCI activating the SPS PDSCH in response to the CORESET pool identifier being configured.

Clause 13. The apparatus of clause 11 or clause 12, wherein the one or more predefined rules further indicate the SPS PDSCH is configured to use the selected TCI state that corresponds to a smallest TRP identifier of TRP identifiers associated with the first number of TCI states.

Clause 14. The apparatus of any of clauses 11 to 13, wherein the one or more predefined rules further indicate the SPS PDSCH is configured to use the selected TCI state that corresponds to a smallest TCI identifier of TCIs associated with the first number of TCI states in response to the DCI indicating the TCIs associated with the first number of TCI states that are from a same control resource set (CORESET) pool.

Clause 15. The apparatus of clause 10, wherein the first number of TCI states indicated in the DCI is less than the second number of TCI states, and the one or more processors, individually or in combination, are further operable to cause the apparatus to detect the switch from the mTRP mode to the sTRP mode based on the second number of TCI states being greater than the first number of TCI states.

Clause 16. The apparatus of clause 15, wherein the one or more predefined rules further indicate the SPS PDSCH or the CG PUSCH is configured to become disabled after an application time of the selected TCI state until a next downlink control signaling indicates another switch between the mTRP mode and the sTRP mode in the UE in response to the SPS PDSCH or the CG PUSCH being configured for spatial division multiplexing (SDM) and the first number of TCI states indicated in the DCI being less than a number of data layers of the UE.

Clause 17. The apparatus of clause 15 or 16, wherein the one or more predefined rules further indicate the SPS PDSCH or the CG PUSCH is configured to use the selected TCI state associated with the first number of TCI states in response to the SPS PDSCH or the CG PUSCH being configured for time division multiplexing (TDM) or frequency division multiplexing (FDM).

Clause 18. The apparatus of any of clauses 15 to 17, wherein the one or more predefined rules further indicate the SPS PDSCH is configured to use a TCI state associated with the second number of TCI states.

Clause 19. The apparatus of any of clauses 10 to 18, wherein the one or more processors, individually or in combination, are further operable to cause the apparatus to receive, from the network entity, a configuration indicating one or more sounding reference signal (SRS) resource indicators (SRIs), the one or more SRIs informing the UE that the selected TCI state is applied to Type 1 CG PUSCH repetitions in the CG PUSCH.

Clause 20. The apparatus of clause 19, wherein the selected TCI state associated with the first number of TCI states is applied to the Type 1 CG PUSCH repetitions associated with an SRS resource set in response to the configuration indicating a plurality of SRIs and the first number of TCI states indicating a plurality of TCI states.

Clause 21. The apparatus of clause 19 or 20, wherein the selected TCI state associated with the first number of TCI states is applied to the Type 1 CG PUSCH repetitions in response to the configuration indicating a single SRI and the first number of TCI states indicating a plurality of TCI states.

Clause 22. The apparatus of any of clauses 1 to 21, wherein the one or more processors, individually or in combination, are further operable to cause the apparatus to, in response to the DCI being received on a first component carrier, the DCI indicating a scheduled physical downlink shared channel (PDSCH) on a second component carrier different than the first component carrier, the selected TCI state being associated with a non-serving cell, and a scheduling time offset between reception of the DCI and the scheduled PDSCH being smaller than a time offset threshold: receive, in a scheduling slot of the scheduled PDSCH, a medium access control (MAC) control element (MAC-CE) indicating a plurality of TCI identifiers in a PDSCH TCI list activated by the MAC-CE, wherein the selected TCI state corresponds to a lowest TCI identifier of the plurality of TCI identifiers for an active bandwidth part (BWP) of the second component carrier with the scheduled PDSCH, and determine a quasi-co-location (QCL) assumption for the scheduled PDSCH based on the selected TCI state.

Clause 23. The apparatus of any of clauses 1 to 22, wherein the one or more processors, individually or in combination, are further operable to cause the apparatus to receive, from the network entity, a configuration that configures the UE to report channel state information (CSI) based on a Type II codebook for coherent joint transmission (CJT) in the mTRP mode.

Clause 24. The apparatus of clause 23, wherein the one or more processors, individually or in combination, are further operable to cause the apparatus to transmit, to the network entity, UE capability information indicating support for CSI reporting of CJT operations based on the Type II codebook for CJT in the mTRP mode.

Clause 25. The apparatus of clause 23 or 24, wherein the Type II codebook for CJT in the mTRP mode is an extension based on one or more of an enhanced Type-II regular codebook, a further-enhanced Type-II port selection codebook, or a codebook dedicated for CJT operation.

Clause 26. An apparatus for wireless communication at a user equipment (UE), comprising: means for receiving, from a network entity, downlink control information (DCI) indicating a first number of transmission configuration indication (TCI) states; means for detecting a switch between a multiple transmission and reception point (mTRP) mode and a single TRP (sTRP) mode in the UE based on the first number of TCI states being different than a second number of TCI states which were previously received by the UE; and means for communicating with the network entity in one or more channels configured to use a selected TCI state associated with the first number of TCI states using one or more predefined rules based on the switch between the mTRP mode and the sTRP mode.

Clause 27. A method of wireless communication performed by a user equipment (UE), the method comprising: receiving, from a network entity, downlink control information (DCI) indicating a first number of transmission configuration indication (TCI) states; detecting a switch between a multiple transmission and reception point (mTRP) mode and a single TRP (sTRP) mode in the UE based on the first number of TCI states being different than a second number of TCI states which were previously received by the UE; and communicating with the network entity in one or more channels configured to use a selected TCI state associated with the first number of TCI states using one or more predefined rules based on the switch between the mTRP mode and the sTRP mode.

Clause 28. The method of clause 27, wherein the one or more channels includes a physical downlink control channel (PDCCH) associated with a control resource set (CORESET) that is preconfigured to use the second number of TCI states, and the one or more predefined rules indicate the CORESET is configured to switch an associated TCI state from a TCI state associated with the second number of TCI states to the selected TCI state associated with the first number of TCI states based on the switch between the mTRP mode and the sTRP mode.

Clause 29. The method of clause 27 or 28, wherein the one or more channels includes a semi-persistent scheduling (SPS) physical downlink shared channel (PDSCH) or a configured grant (CG) physical uplink shared channel (PUSCH) that is preconfigured to use the second number of TCI states, and the one or more predefined rules indicate the SPS PDSCH or the CG PUSCH is configured to switch an associated TCI state from a TCI state associated with the second number of TCI states to the selected TCI state associated with the first number of TCI states based on the switch between the mTRP mode and the sTRP mode.

Clause 30. A non-transitory, computer-readable medium comprising computer executable code, the code when executed by one or more processors of a user equipment (UE), causes the one or more processors to, individually or in combination: receive, from a network entity, downlink control information (DCI) indicating a first number of transmission configuration indication (TCI) states; detect a switch between a multiple transmission and reception point (mTRP) mode and a single TRP (sTRP) mode in the UE based on the first number of TCI states being different than a second number of TCI states which were previously received by the UE; and communicate with the network entity in one or more channels configured to use a selected TCI state associated with the first number of TCI states using one or more predefined rules based on the switch between the mTRP mode and the sTRP mode.

The previous description is provided to enable any person of ordinary skill in the art to practice the various aspects described herein. Various modifications to these aspects will be readily apparent to those having ordinary skill in the art, and the generic principles defined herein may be applied to other aspects. Thus, the claims are not intended to be limited to the aspects shown herein, but is to be accorded the full scope consistent with the language. Thus, the language employed herein is not intended to limit the scope of the claims to only those aspects shown herein, but is to be accorded the full scope consistent with the language of the claims.

As one example, the language “determining” may encompass a wide variety of actions, and so may not be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include some communication and/or memory operations/procedures through which some information or value(s) are acquired, such as “receiving” (e.g., receiving information), “accessing” (e.g., accessing data in a memory), “detecting,” and the like.

As another example, reference to an element in the singular is not intended to mean “one and only one” unless specifically so stated, but rather “one or more.” In particular, reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

What is claimed is:

1. An apparatus for wireless communication at a user equipment (UE), comprising:
one or more memories; and
one or more processors each communicatively coupled with at least one of the one or more memories, the one or more processors, individually or in any combination, operable to cause the apparatus to:
receive, from a network entity, downlink control information (DCI) indicating a first number of transmission configuration indication (TCI) states;
detect a switch between a multiple transmission and reception point (mTRP) mode and a single TRP (sTRP) mode in the UE based on the first number of TCI states being different than a second number of TCI states which were previously received by the UE; and
communicate with the network entity in one or more channels configured to use a selected TCI state associated with the first number of TCI states using one or more predefined rules based on the switch between the mTRP mode and the sTRP mode.

2. The apparatus of claim 1, wherein the first number of TCI states includes a single TCI state in the sTRP mode of the UE and a plurality of TCI states in the mTRP mode of the UE.

3. The apparatus of claim 1, wherein the one or more channels includes a physical downlink control channel (PDCCH) associated with a control resource set (CORESET) that is preconfigured to use the second number of TCI states, and the one or more predefined rules indicate the CORESET is configured to switch an associated TCI state from a TCI state associated with the second number of TCI states to the selected TCI state associated with the first number of TCI states based on the switch between the mTRP mode and the sTRP mode.

4. The apparatus of claim 3, wherein the first number of TCI states indicated in the DCI is greater than the second number of TCI states, and the one or more processors, individually or in combination, are further operable to cause the apparatus to detect the switch from the sTRP mode to the mTRP mode based on the second number of TCI states being less than the first number of TCI states.

5. The apparatus of claim 4, wherein the one or more predefined rules further indicate the CORESET is configured to use the selected TCI state that corresponds to a smallest TRP identifier of TRP identifiers associated with the first number of TCI states.

6. The apparatus of claim 4, wherein the one or more predefined rules further indicate the CORESET is configured to use the selected TCI state that corresponds to a CORESET pool identifier in response to the CORESET pool identifier being configured for the CORESET.

7. The apparatus of claim 3, wherein the first number of TCI states indicated in the DCI is less than the second number of TCI states, and the one or more processors, individually or in combination, are further operable to cause the apparatus to detect the switch from the mTRP mode to the sTRP mode based on the second number of TCI states being greater than the first number of TCI states.

8. The apparatus of claim 7, wherein the one or more predefined rules further indicate the CORESET is configured to become disabled after an application time of the selected TCI state until a next downlink control signaling indicates another switch between the mTRP mode and the sTRP mode in the UE.

9. The apparatus of claim 7, wherein the one or more predefined rules further indicate the CORESET is configured to use the selected TCI state from the first number of TCI states that is active for the UE.

10. The apparatus of claim 1, wherein the one or more channels includes a semi-persistent scheduling (SPS) physical downlink shared channel (PDSCH) or a configured grant (CG) physical uplink shared channel (PUSCH) that is preconfigured to use the second number of TCI states, and the one or more predefined rules indicate the SPS PDSCH or the CG PUSCH is configured to switch an associated TCI state from a TCI state associated with the second number of TCI states to the selected TCI state associated with the first number of TCI states based on the switch between the mTRP mode and the sTRP mode.

11. The apparatus of claim 10, wherein the first number of TCI states indicated in the DCI is greater than the second number of TCI states, and the one or more processors, individually or in combination, are further operable to cause the apparatus to detect the switch from the sTRP mode to the mTRP mode based on the second number of TCI states being less than the first number of TCI states.

12. The apparatus of claim 11, wherein the one or more predefined rules further indicate the SPS PDSCH is configured to use the selected TCI state that corresponds to a control resource set (CORESET) pool identifier associated with the DCI activating the SPS PDSCH in response to the CORESET pool identifier being configured.

13. The apparatus of claim 11, wherein the one or more predefined rules further indicate the SPS PDSCH is configured to use the selected TCI state that corresponds to a smallest TRP identifier of TRP identifiers associated with the first number of TCI states.

14. The apparatus of claim 11, wherein the one or more predefined rules further indicate the SPS PDSCH is configured to use the selected TCI state that corresponds to a smallest TCI identifier of TCIs associated with the first number of TCI states in response to the DCI indicating the TCIs associated with the first number of TCI states that are from a same control resource set (CORESET) pool.

15. The apparatus of claim 10, wherein the first number of TCI states indicated in the DCI is less than the second number of TCI states, and the one or more processors, individually or in combination, are further operable to cause the apparatus to detect the switch from the mTRP mode to the sTRP mode based on the second number of TCI states being greater than the first number of TCI states.

16. The apparatus of claim 15, wherein the one or more predefined rules further indicate the SPS PDSCH or the CG PUSCH is configured to become disabled after an application time of the selected TCI state until a next downlink control signaling indicates another switch between the mTRP mode and the sTRP mode in the UE in response to the SPS PDSCH or the CG PUSCH being configured for spatial division multiplexing (SDM) and the first number of TCI states indicated in the DCI being less than a number of data layers of the UE.

17. The apparatus of claim 15, wherein the one or more predefined rules further indicate the SPS PDSCH or the CG PUSCH is configured to use the selected TCI state associated with the first number of TCI states that are active for the UE in response to the SPS PDSCH or the CG PUSCH being configured for time division multiplexing (TDM) or frequency division multiplexing (FDM).

18. The apparatus of claim 15, wherein the one or more predefined rules further indicate the SPS PDSCH is configured to use a TCI state associated with the second number of TCI states that are preconfigured for the UE.

19. The apparatus of claim 10, wherein the one or more processors, individually or in combination, are further operable to cause the apparatus to receive, from the network entity, a configuration indicating one or more sounding reference signal (SRS) resource indicators (SRIs), the one or more SRIs informing the UE that the selected TCI state is applied to Type 1 CG PUSCH repetitions in the CG PUSCH.

20. The apparatus of claim 19, wherein the selected TCI state associated with the first number of TCI states is applied to the Type 1 CG PUSCH repetitions associated with an SRS resource set in response to the configuration indicating a plurality of SRIs and the first number of TCI states indicating a plurality of TCI states.

21. The apparatus of claim 19, wherein the selected TCI state associated with the first number of TCI states is applied to the Type 1 CG PUSCH repetitions in response to the configuration indicating a single SRI and the first number of TCI states indicating a plurality of TCI states.

22. The apparatus of claim 1, wherein the one or more processors, individually or in combination, are further operable to cause the apparatus to, in response to the DCI being received on a first component carrier, the DCI indicating a scheduled physical downlink shared channel (PDSCH) on a second component carrier different than the first component carrier, the selected TCI state being associated with a non-serving cell, and a scheduling time offset between reception of the DCI and the scheduled PDSCH being smaller than a time offset threshold:
receive, in a scheduling slot of the scheduled PDSCH, a medium access control (MAC) control element (MAC-CE) indicating a plurality of TCI identifiers in a PDSCH TCI list activated by the MAC-CE, wherein the selected TCI state corresponds to a lowest TCI identifier of the plurality of TCI identifiers for an active bandwidth part (BWP) of the second component carrier with the scheduled PDSCH, and
determine a quasi-co-location (QCL) assumption for the scheduled PDSCH based on the selected TCI state.

23. The apparatus of claim 1, wherein the one or more processors, individually or in combination, are further operable to cause the apparatus to receive, from the network entity, a configuration that configures the UE to report channel state information (CSI) based on a Type II codebook for coherent joint transmission (CJT) in the mTRP mode.

24. The apparatus of claim 23, wherein the one or more processors, individually or in combination, are further operable to cause the apparatus to transmit, to the network entity, UE capability information indicating support for CSI reporting of CJT operations based on the Type II codebook for CJT in the mTRP mode.

25. The apparatus of claim 23, wherein the Type II codebook for CJT in the mTRP mode is an extension based on one or more of an enhanced Type-II regular codebook, a further-enhanced Type-II port selection codebook, or a codebook dedicated for CJT operation.

26. An apparatus for wireless communication at a user equipment (UE), comprising:
means for receiving, from a network entity, downlink control information (DCI) indicating a first number of transmission configuration indication (TCI) states;
means for detecting a switch between a multiple transmission and reception point (mTRP) mode and a single TRP (sTRP) mode in the UE based on the first number of TCI states being different than a second number of TCI states which were previously received by the UE; and
means for communicating with the network entity in one or more channels configured to use a selected TCI state associated with the first number of TCI states using one or more predefined rules based on the switch between the mTRP mode and the sTRP mode.

27. A method of wireless communication performed by a user equipment (UE), the method comprising:
receiving, from a network entity, downlink control information (DCI) indicating a first number of transmission configuration indication (TCI) states;
detecting a switch between a multiple transmission and reception point (mTRP) mode and a single TRP (sTRP) mode in the UE based on the first number of TCI states being different than a second number of TCI states which were previously received by the UE; and
communicating with the network entity in one or more channels configured to use a selected TCI state associated with the first number of TCI states using one or more predefined rules based on the switch between the mTRP mode and the sTRP mode.

28. The method of claim 27, wherein the one or more channels includes a physical downlink control channel (PDCCH) associated with a control resource set (CORESET) that is preconfigured to use the second number of TCI states, and the one or more predefined rules indicate the CORESET is configured to switch an associated TCI state from a TCI state associated with the second number of TCI states to the selected TCI state associated with the first number of TCI states based on the switch between the mTRP mode and the sTRP mode.

29. The method of claim 27, wherein the one or more channels includes a semi-persistent scheduling (SPS) physical downlink shared channel (PDSCH) or a configured grant (CG) physical uplink shared channel (PUSCH) that is preconfigured to use the second number of TCI states, and the one or more predefined rules indicate the SPS PDSCH or the CG PUSCH is configured to switch an associated TCI state from a TCI state associated with the second number of TCI states to the selected TCI state associated with the first number of TCI states based on the switch between the mTRP mode and the sTRP mode.

30. A non-transitory, computer-readable medium comprising computer executable code, the code when executed by one or more processors of a user equipment (UE), causes the one or more processors to, individually or in combination:
receive, from a network entity, downlink control information (DCI) indicating a first number of transmission configuration indication (TCI) states;
detect a switch between a multiple transmission and reception point (mTRP) mode and a single TRP (sTRP) mode in the UE based on the first number of TCI states being different than a second number of TCI states which were previously received by the UE; and
communicate with the network entity in one or more channels configured to use a selected TCI state associated with the first number of TCI states using one or more predefined rules based on the switch between the mTRP mode and the sTRP mode.
